(19) United States
(12) Patent Application Publication
(10) Pub. No.: US 2008/0063048 A1
(43) Pub. Date: Mar. 13, 2008

(54) DISPLAY APPARATUS

(75) Inventors: Akihiro Ouchi, Tokyo (JP); Yukihiko Sakashita, Kawasaki-shi (JP); Ryosuke Mizuno, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/853,171

(22) Filed: Sep. 11, 2007

(30) Foreign Application Priority Data
Sep. 13, 2006 (JP) 2006-248573

(51) Int. Cl. H04N 7/00

(52) U.S. Cl. 375/240.01

(57) ABSTRACT

A display apparatus comprises an input unit adapted to input frame data; a memory adapted to store frame data; a decision unit adapted to decide correction data by comparing the frame data that has been input and the frame data that immediately precedes the input frame data in the memory; an add-on unit adapted to add the decided correction data onto the frame data that has been input; a storage control unit adapted to store the input frame data, onto which the correction data has been added, in the memory; a correction unit adapted to read out the frame data, which has been stored in the memory, at a predetermined frame rate, and to correct the frame data based upon the correction data that has been added onto the frame data; and a display control unit adapted to display an image on the monitor based upon the corrected frame data.

### BACKGROUND OF THE INVENTION

1. Field of the Invention

The present invention relates to a display apparatus and, more particularly, to a liquid crystal display technique for improving liquid crystal response speed with respect to a change in an input video signal.

2. Description of the Related Art

A liquid crystal display apparatus has recently come to be used as the display apparatus of TV receivers and personal computers. Owing to its thin profile, space-saving and power-saving features, such a liquid crystal display apparatus has come into widespread use. However, since the liquid crystal response speed from a change in the input video signal to actual presentation of the display is slow, a problem with a liquid crystal display apparatus is that a residual image appears when a moving picture is displayed. Accordingly, in order to improve liquid crystal response speed, so-called “lover-voltage drive” has been proposed (see U.S. Pat. No. 3,305,240). This technique compares the video signal displayed in a succeeding frame and the video signal displayed in the immediately preceding frame and drives the liquid crystal upon correcting the input video signal in accordance with the result of the comparison. The effect of improving liquid crystal response speed is enhanced further by performing over-voltage drive in short periods. To accomplish this, a known arrangement is to drive the liquid crystal upon dividing one input frame into a plurality of fields and perform over-voltage drive in the initial field (see Japanese Patent Application Laid-Open No. 2001-343956).

The principle of over-voltage drive will be described in simple terms with reference to FIGS. 9 and 10. FIG. 9 is a schematic view exemplifying a liquid crystal drive signal and a liquid crystal response characteristic in a case where over-voltage drive is performed at a frame rate identical with that of an input video signal. FIG. 10 is a schematic view exemplifying a liquid crystal drive signal and a liquid crystal response characteristic in a case where a conversion is made to a frame rate that is double the frame rate of an input video signal and over-voltage drive is performed in the initial field after the conversion.

In FIG. 9, time is plotted along the horizontal axis, and the vertical axis is a plot of the signal and the level of the response to this signal. Reference numerals 901, 902, 903 and 904 indicate a change in an ordinary liquid crystal drive signal, a liquid crystal response to the liquid crystal drive signal 901, a change in a liquid crystal drive signal that has undergone over-voltage drive, and a liquid crystal response to the liquid crystal drive signal 903, respectively. As will be understood from a comparison of the liquid crystal responses 902 and 904, the liquid crystal response speed is raised by subjecting the liquid crystal to over-voltage drive.

In FIG. 10 as well, time is plotted along the horizontal axis, and the vertical axis is a plot of the signal and the level of the response to this signal. Reference numerals 1001, 1002, 1003 and 1004 indicate a change in an ordinary liquid crystal drive signal, a liquid crystal response to the liquid crystal drive signal 1001, a change in a liquid crystal drive signal that has undergone over-voltage drive, and a liquid crystal response to the liquid crystal drive signal 1003, respectively. As will be understood from a comparison of the liquid crystal responses 904 and 1004, the liquid crystal response speed is raised further in FIG. 10, in which the frame rate has been converted to the doubled frame rate.

The arrangement for thus dividing one frame into a plurality of fields and performing over-voltage drive in the initial field is compatible with a method of driving a LCOS (Liquid Crystal On Silicon) panel. The reason is that a LCOS panel, which is a reflective liquid crystal panel, converts the frame rate of the input signal to double the frame rate and performs a polarity inversion every double-speed field of the double-speed frame.

In order to convert the input signal to one having double the frame rate (i.e., in order to achieve the double-speed conversion), it is necessary to store one frame of the video signal in a frame memory and read out the signal at double the speed. Further, in order to perform over-voltage drive for improving liquid crystal response speed, it is necessary to store the immediately preceding frame of the video signal in a frame memory in order to compare the present frame of the video signal and the immediately preceding frame of the video signal. In other words, frame memories are required in respective processing blocks. Providing a frame memory separately for each block enlarges overall frame-memory size and their controllers and results in more complicated control.

In order to deal with this, a liquid crystal display apparatus in which a frame memory for the double-speed conversion and a frame memory for over-voltage drive are made a common frame memory has been proposed (Japanese Patent Application Laid-Open No. 2005-309326). This example of the prior art will be described with reference to FIG. 7. FIG. 7 is a processing block relating to a double-speed conversion and over-voltage drive in a conventional liquid crystal display.

Input video signal data Din is supplied to a first frame memory 21 and second frame memory 22 constructing a frame memory block 20. The frame memories 21 and 22 are so adapted that their write and read operations are capable of being controlled independently. The outputs of the frame memories 21 and 22 are connected to a correction processor 24. The correction processor 24 generates and outputs display data that has been subjected to moving-image correction processing based upon video signal data that has been read out of the frame memories 21 and 22.

Next, reference will be had to FIG. 8 to describe the details of the write and read operations of these two frame memories 21, 22 in the example of the prior art. FIG. 8 is a schematic view illustrating the timing of the write and read operations of the two frame memories 21 and 22.

At input of a frame Fn−1, write control of the first frame memory 21 is activated (801) and input video signal data Din is written to the first frame memory 21, as illustrated at (a) in FIG. 8. On the other hand, the second frame memory 22 does not undergo a write operation. Instead, the second frame memory 22 reads out the video signal data stored in the preceding frame Fn−2 at twice the rate (802), as illustrated at (d) in FIG. 8.

At the moment the writing of the video signal data in the first frame memory 21 reaches the half-way point in the time period of frame Fn−1, read-out starts (803), as illustrated at (b) in FIG. 8, and the video data of frame Fn−1 is read out at twice the rate. The read-out of the video signal data of frame Fn−1 is repeated four times, as represented at A1, B1, C1, D1 in (b) of FIG. 8, until the video signal data that has been stored in the first frame memory 21 is updated in frame Fn+1.

Similarly, at input of the next frame Fn, write control of the first frame memory 21 is activated (804) and input video signal data Din is written to the second frame memory 22, as illustrated at (c) in FIG. 8. On the other hand, the first frame memory 21 does not undergo a write operation. Instead, read-out of video signal data that was stored in the preceding frame Fn−1 is performed at twice the rate (805), as illustrated at (b) in FIG. 8.

At the moment the writing of the video signal data in the second frame memory 22 reaches the half-way point in the time period of frame Fn, read-out starts (806), as illustrated at (d) in FIG. 8, and the video data of frame Fn is read out at twice the rate. The read-out of the video signal data of frame Fn is repeated four times, as represented at A2, B2, C2, D2 in (d) of FIG. 8, until the video signal data that has been stored in second first frame memory 22 is updated in frame Fn+2.

Note should be taken of the time periods in which the video signal data of frame Fn is read out of the second frame memory 22 at (d) in FIG. 8. In the periods indicated at A2, B2 among the four read-out cycles, read-out of video signal data of frame Fn−1 in the periods indicated at C1, D1 is performed in parallel in the first frame memory.

The correction processor 24 of FIG. 7 adopts the video signal data of frame Fn, which is output from the second frame memory 22 in periods A2, B2, as the data of the present frame. Further, the correction processor 24 adopts the video signal data of frame Fn−1, which is output from the first frame memory 21 in periods C1, D1, as the data of the preceding frame. The correction processor 24 of FIG. 7 compares these items of video signal data. As a result of the comparison, the correction processor 24 generates and outputs video signal data, which has been subjected to correction processing that emphasizes the change, based upon a combination of video signal data in which a difference in signal levels has occurred.

The read-out time periods C2, D2 of Fn in the second frame memory 22 are utilized by the correction processor 24 as the data of the preceding frame with respect to frame Fn+1. As the data of the present frame at this time, use is made of the read-out video signal data corresponding to the two frames Fn+1 in the first half among the four read-out cycles in the first frame memory 21.

By repeating the above-described operation, the frame-rate conversion of the display data and over-voltage drive can be implemented simultaneously.

In the arrangement described in Japanese Patent Application Laid-Open No. 2005-309326, however, the data paths of the present and preceding frames that arrive after being read out of the frame memories in order to perform the data comparison are interchanged alternatingly. Consequently, control of the correction processor is complicated. Furthermore, since the items of video signal data of the present and preceding frames are read out in parallel, two independent frame memories are required.

### SUMMARY OF THE INVENTION

The present invention has been devised in view of the problems mentioned above and seeks to provide a display technique that makes it possible to improve the liquid crystal response speed characteristic without resulting in a complicated structure and control.

According to one aspect of the present invention, a display apparatus to which video signal data including a plurality of frame data is input for displaying an image on a monitor based upon the video signal data, the apparatus comprises:

an input unit adapted to input frame data;

a frame memory adapted to store frame data;

a decision unit adapted to decide correction data by comparing the frame data that has been input by the input unit and the frame data that immediately precedes the input frame data that has been stored in the frame memory;

an add-on unit adapted to add the decided correction data onto the frame data that has been input;

a storage control unit adapted to store the input frame data, onto which the correction data has been added, in the frame memory;

a correction unit adapted to read out the frame data, which has been stored in the frame memory by the storage control unit, at a predetermined frame rate, and to correct the frame data based upon the correction data that has been added onto the frame data; and

a display control unit adapted to display an image on the monitor based upon the corrected frame data.

According to another aspect of the present invention, a display apparatus to which video signal data including a plurality of frame data is input for displaying an image on a monitor based upon the video signal data, the apparatus comprises:

an input unit adapted to input frame data;

a first frame memory adapted to store frame data;

a decision unit adapted to decide correction data by comparing the frame data that has been input by the input unit and the frame data that immediately precedes the input frame data that has been stored in the first frame memory;

a second frame memory adapted to store the correction data that has been decided by the decision unit

a storage control unit adapted to store the input frame data in the first frame memory;

a correction unit adapted to read the frame data and the correction data out of the first frame memory and the second frame memory, respectively, at a predetermined frame rate and to correct the frame data based upon the correction data; and

a display control unit adapted to display an image on the monitor based upon the corrected frame data.

According to still another aspect of the present invention, a method of controlling a display apparatus to which video signal data including a plurality of frame data is input for displaying an image on a monitor based upon the video signal data, the apparatus having a frame memory for storing the frame data, the method comprises:

an input step of inputting frame data;

a decision step of deciding correction data by comparing the frame data that has been input at the input step and frame data that immediately precedes the input frame data that has been stored in the frame memory;

an add-on unit step of adding the decided correction data onto the frame data that has been input;

a storage control step of storing the input frame data, onto which the correction data has been added, in the frame memory;

a correction step of reading out the frame data, which has been stored in the frame memory at the storage control step, at a predetermined frame rate, and correcting the frame data based upon the correction data that has been added onto the frame data; and

a display control step of displaying an image on the monitor based upon the corrected frame data.

Further features of the present invention will become apparent from the following description of exemplary embodiments with reference to the attached drawings.

### BRIEF DESCRIPTION OF THE DRAWINGS

FIG. 1 is a block diagram illustrating the structure of a liquid crystal display apparatus according to a first embodiment of the present invention;

FIG. 2 is a schematic view illustrating the timing of write and read operations of frame memories;

FIG. 3 is a schematic view illustrating the timing of write and read operations of frame memories;

FIG. 4 is a block diagram illustrating the structure of a liquid crystal display apparatus according to a second embodiment of the present invention;

FIG. 5 is a schematic view illustrating the timing of write and read operations of frame memories;

FIG. 6 is a block diagram illustrating the structure of a liquid crystal display apparatus according to a third embodiment of the present invention;

FIG. 7 is a block diagram illustrating the structure of a liquid crystal display apparatus according to the prior art;

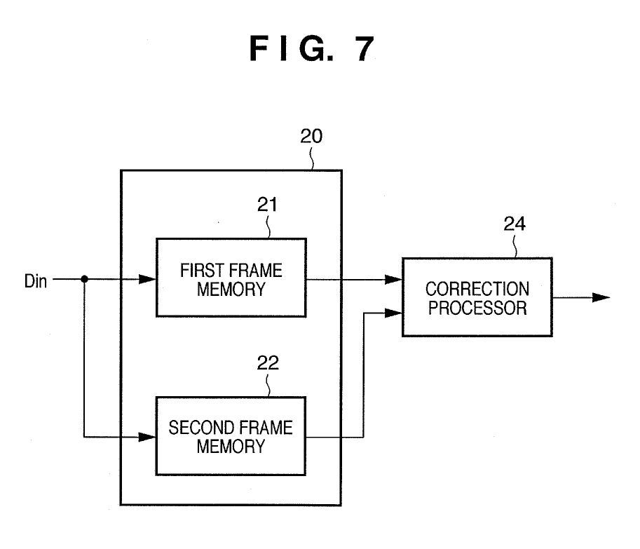

FIG. 8 is a schematic view illustrating the timing of write and read operations of frame memories;

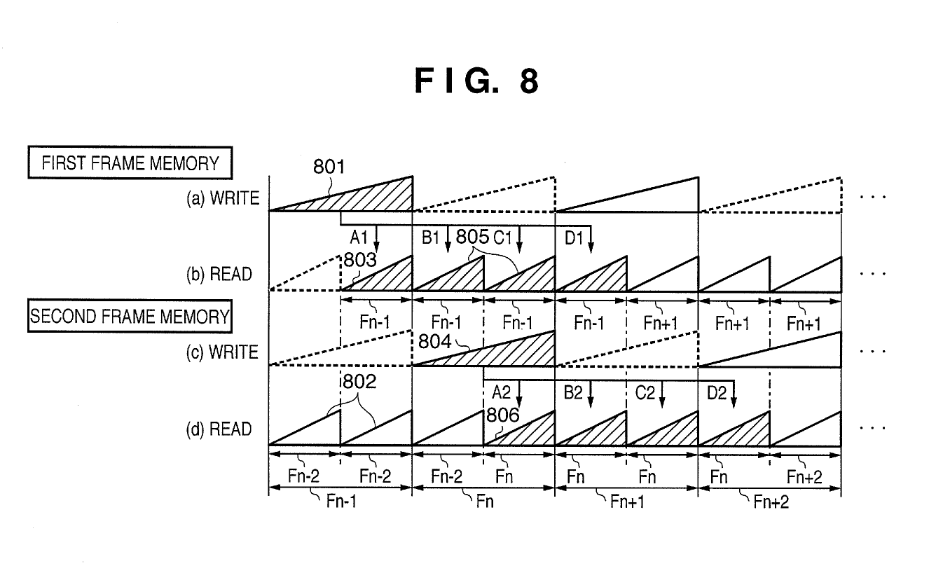

FIG. 9 is a schematic view exemplifying a liquid crystal drive signal and a liquid crystal response characteristic; and

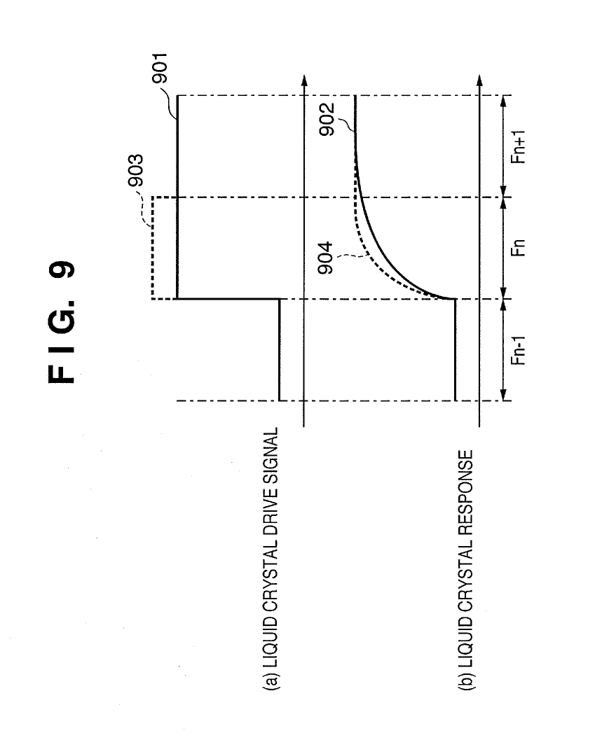

FIG. 10 is a schematic view exemplifying a liquid crystal drive signal and a liquid crystal response characteristic.

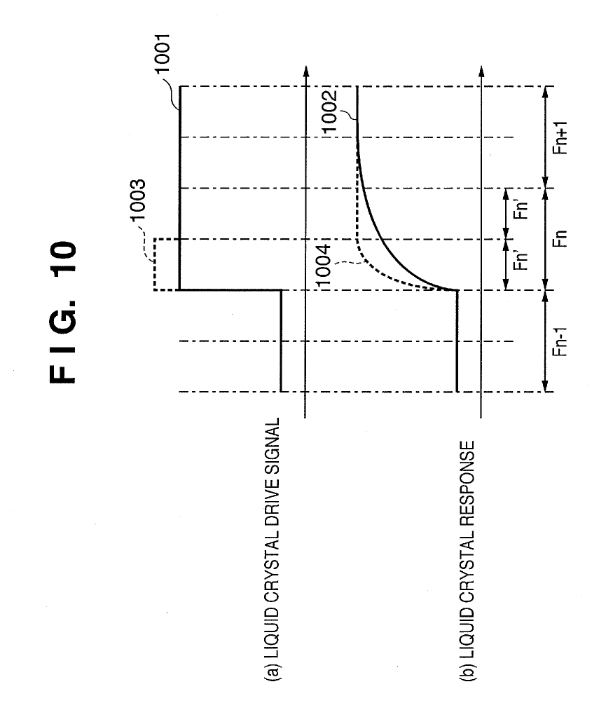

### DESCRIPTION OF THE EMBODIMENTS

Preferred embodiments of the present invention will now be described in detail with reference to the drawings. It should be noted that these embodiments are for illustrative purposes only and that the scope of the invention is not limited to these embodiments.

### First Embodiment

### (Structure of Liquid Crystal Display Apparatus)

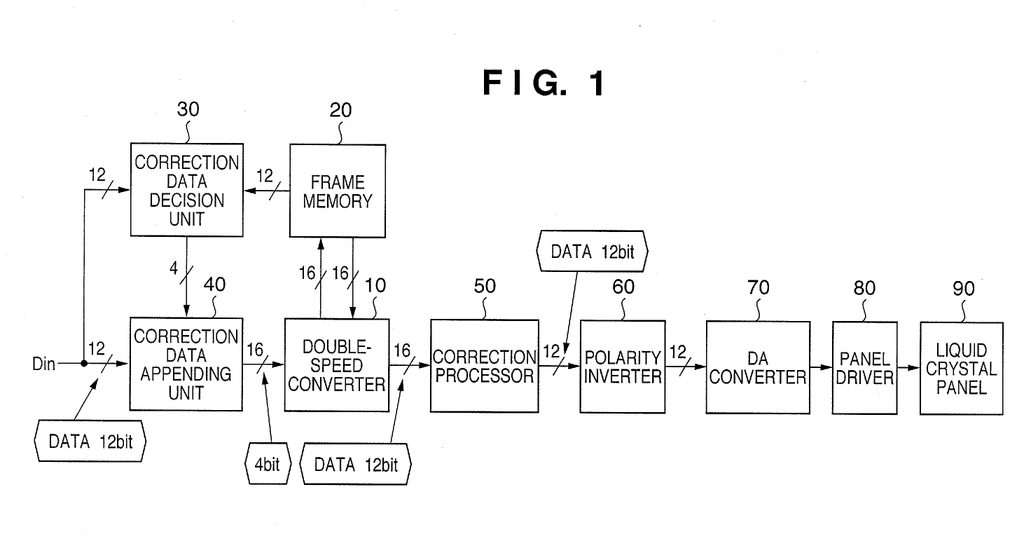

FIG. 1 is a block diagram illustrating a liquid crystal display apparatus according to a first embodiment of the present invention. The apparatus includes a double-speed converter 10, a frame memory 20, a correction data decision unit 30, a correction data appending unit 40, a correction processor 50, a polarity inverter 60, a DA converter 70, a panel driver 80 and a liquid crystal panel 90.

The double-speed converter 10 writes video signal data, which enters from the correction data appending unit 40, to the frame memory 20. The double-speed converter 10 reads out video signal data, which has been stored in the frame memory 20, at a rate that is double the frame rate of the input video signal data, thereby generating video signal data that has undergone a double-speed conversion, and outputs this data to the correction processor 50.

The correction data decision unit 30 reads out video signal data of the preceding frame, which has been stored in the frame memory 20, at a rate identical with the frame rate of the input and compares the signal level with that of video signal data Din of the present frame. Based upon the result of the comparison, the correction data decision unit 30 delivers an output to the correction data appending unit 40 as correction data of, e.g., four bits. The correction data appending unit 40 adds on the 4-bit correction data to the MSB or LSB of the video signal data Din of the present frame that is input as, e.g., 12 bits, thereby outputting 16-bit correction data to the double-speed converter 10. It should be noted that this correction data includes information indicating the level of over-voltage drive.

The correction processor 50 refers to the MSB or LSB 4-bit correction data from the 16-bit data that is input following the double-speed conversion, and generates corrected 12-bit video signal data. The correction of the video signal data can be applied to the video signal of the double-speed frame rate in only one field, namely in either the initial double-speed field or the following double-speed field.

Alternatively, it is also possible to perform the correction of the video signal data in both of the double-speed fields or to not perform the correction at all.

The polarity inverter 60 outputs a video signal to the DA converter 70. This video signal is such that with respect to the common voltage, the polarity of the voltage supplied to the liquid crystal panel 90 becomes positive in one double-speed field and negative in the other double-speed field. The DA converter 70 converts the video signal data, which has undergone the polarity inversion, to an analog signal. The liquid crystal panel 90 is driven by the analog signal via the panel driver 80. The panel driver 80 may be incorporated within the DA converter 70. It goes without saying that if the input to the liquid crystal panel 90 is a digital input, the DA converter 70 and panel driver 80 will be unnecessary.

(Write and Read Operations)

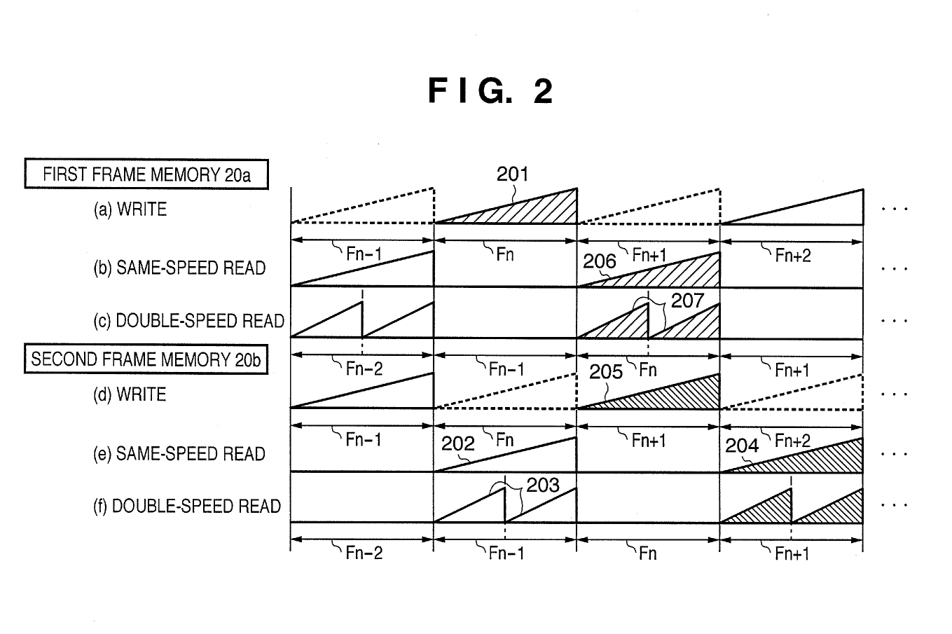

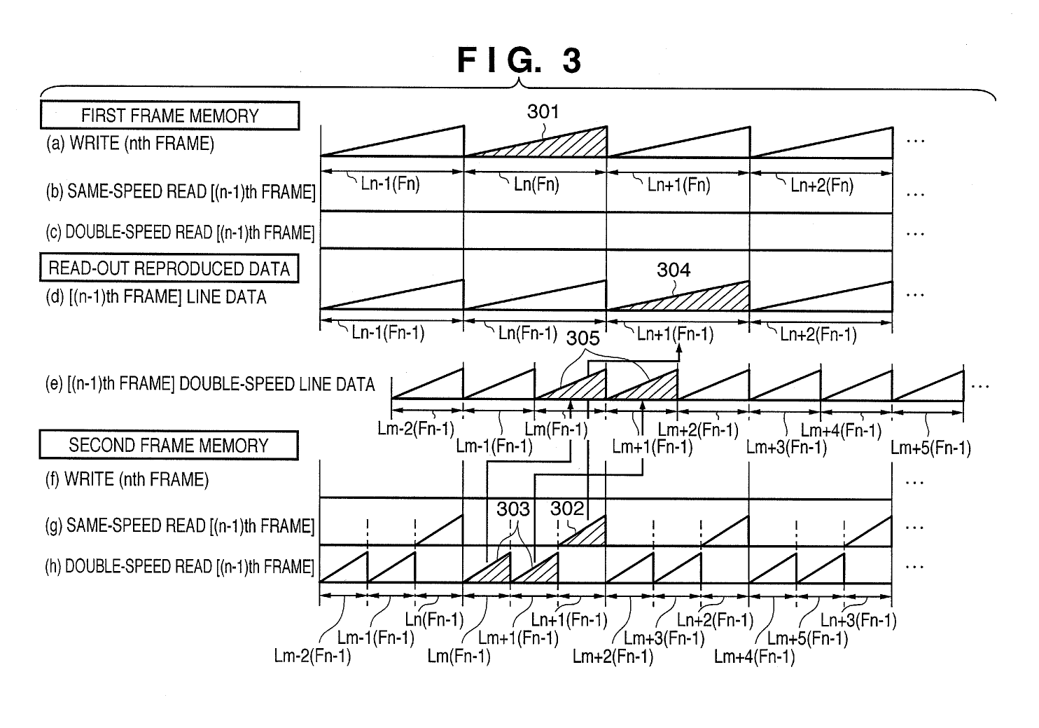

Next, the write and read operations of the frame memory 20 in this embodiment will be described in detail with reference to FIGS. 2 and 3. FIG. 2 is a timing chart for describing the write and read operations of the frame memory 20 in frame periods. It should be noted that the frame memory 20 is constituted by a first frame memory 20a and a second frame memory 20b (not shown) in this embodiment.

When frame Fn is being input as Din, write control of the first frame memory 20a is activated and video signal data is written to the first frame memory 20a, as illustrated at (a) in FIG. 2 (201). Meanwhile, the second frame memory 20b does not perform a write operation. The second frame memory 20b performs read-out of video signal data, which was stored at the preceding frame Fn−1, at a rate identical with that of the input video signal Din (same-speed read-out; 202), as illustrated at (e) in FIG. 2, and at double the rate (double-speed read-out; 203), as illustrated at (f) in FIG. 2. Video signal data (202, 204) that has been read out at a rate identical with that of the input video signal Din, as illustrated at (b) in FIG. 2, is utilized in the correction data decision unit 30 as data of the preceding frame in order to be compared with the input video signal data Din of the present frame of data. The correction data decision unit 30 decides correction data, which is for execution of correction processing in the correction processor 50, with respect to a combination of video signal data in which a difference in signal levels has occurred between the present frame of data and preceding frame of data. Further, the video signal data that is written to the first frame memory 20a is data obtained by adding the correction data, which has been decided by the correction data decision unit 30, onto the MSE or LSB.

Similarly, in the next frame Fn+1, write control of the second frame memory 20b is activated and video signal data is written to the second frame memory 20b, as illustrated at (d) in FIG. 2 (205). Meanwhile, the first frame memory 20a does not perform a write operation. The first frame memory 20a performs read-out of video signal data, which was stored at the preceding frame Fn, at a rate identical with that of the input video signal Din (206), as illustrated at (b) in FIG. 2, and at double the rate (207), as illustrated at (c) in FIG. 2.

Video signal data (206) that has been read out at a rate identical with that of the input video signal Din, as illustrated at (b) in FIG. 2, is utilized in the correction data decision unit 30 as data of the preceding frame in order to be compared with the input video signal data Din of the present frame of data. The correction data decision unit 30 decides correction data, which is for execution of correction processing in the correction processor 50, with respect to a combination of video signal data in which a difference in signal levels has occurred between the present frame of data and preceding frame of data. Further, the video signal data that is written to the second frame memory 20b is data obtained by adding the correction data, which has been decided by the correction data decision unit 30, onto the MSB or LSB.

The writing and reading of video signal data will be described in further detail with reference to FIG. 3. FIG. 3 is a timing chart useful in describing write and read operations of frame memory 20 in the line intervals of frame Fn. In frame Fn, write control of first frame memory 20a is activated and the video signal data is written to the first frame memory 20a line by line (301), as illustrated at (a) in FIG. 3. Meanwhile, the second frame memory 20b does not perform a write operation. The second frame memory 20b reads out data of line Ln+1 of the video signal, which was stored at the preceding frame Fn−1, in one-third the period of line Ln, as illustrated at (g) in FIG. 3 (302). Further, the second frame memory 20b reads out the data of lines Lm and Lm+1 of the video signal, which was stored at the preceding frame Fn−1, in two-thirds the period of line Ln, as illustrated at (h) in FIG. 3 (303).

The video signal data that is read out of the second frame memory is stored temporarily in respective line memories, not shown. The video signal data that has been read out at (g) in FIG. 3 is reproduced as video signal data of line Ln+1 in the preceding frame Fn−1, as indicated at 304 in (d) of FIG. 3, in sync with line Ln=1 of the input video signal Vin, which is the present frame of data. The reproduced video signal data of line Ln+1 is utilized in the correction data decision unit 30 in order to be compared with the input video signal data Din of line Ln+1 of the present frame. The video signal data (303) read out at (h) in FIG. 3 is reproduced as video signal data of line Lm and line Lm+1 in the preceding frame Fn−1, as indicated at 305 in (e) of FIG. 3, at a timing shifted by one-half period relative to the present frame.

It should be noted that the video signal data of the preceding frame Fn−1 that is read out, as illustrated at (e) of FIG. 3, is read out repeatedly at a period that is one-half the present frame Fn, thereby becoming double-speed video signal data. In the next frame Fn+1, write control of the second frame memory 20b is activated, read control of the first frame memory 20a is activated and write and read control is carried out in a manner similar to that described above. The correction processor 50 in FIG. 1 executes correction processing for improving response speed by referring to the correction data added onto the MSB or LSB in the data that is read out of the first frame memory 20a or second frame memory 20b at double the speed. By repeating the operations described above, the frame rate conversion of the input video signal data and the response speed correction processing can be performed simultaneously.

In accordance with the arrangement of this embodiment, the frame memory used in the double-speed conversion and the frame memory used in over-voltage drive can be made a single common frame memory. Further, the comparison of video signal data for over-voltage drive can be performed in sync with the frame rate of the input video signal. Accordingly, it is possible to provide a display technique that enables an improvement in the response speed characteristic of liquid crystal without complicating the memory configuration and control thereof.

Further, it is possible to carry out correction of over-voltage drive in any double-speed field after the double-speed conversion. Accordingly, it is possible to provide a display technique whereby correction processing for improving the response speed characteristic of liquid crystal can be executed appropriately.

In this embodiment, an arrangement in which frames are read out at double the speed in order to perform over-voltage drive has been described by way of example. However, the read-out speed is not limited to double the speed, and read-out can be performed at a suitable rate in accordance with the application and objective.

### Second Embodiment

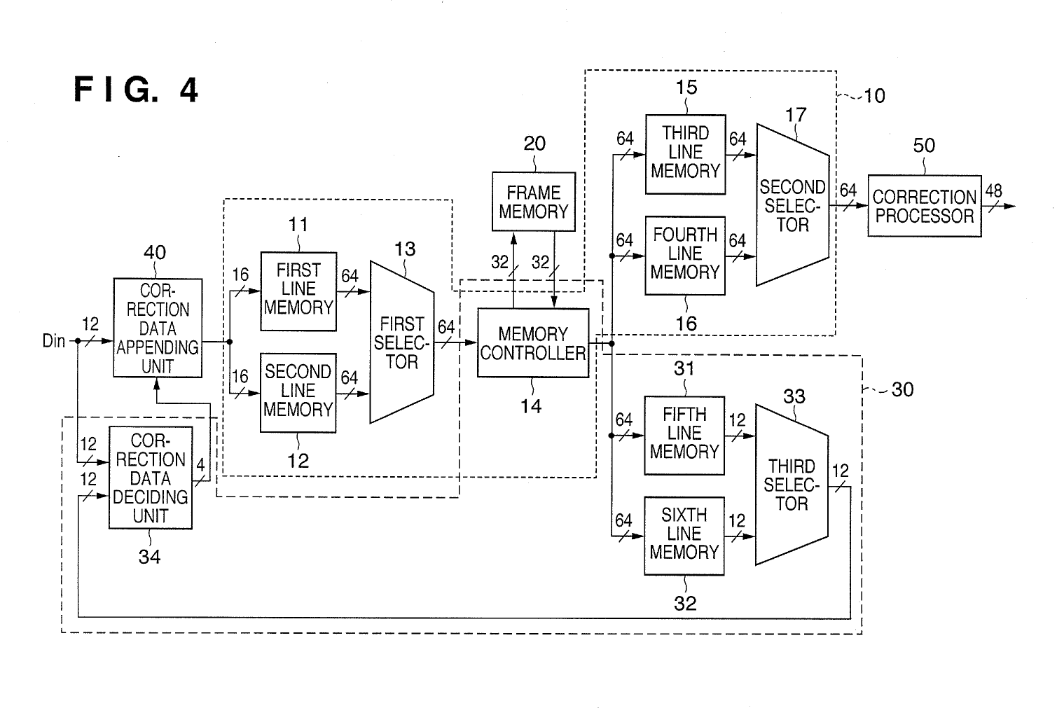

The basic structure of a liquid crystal display apparatus according to a second embodiment of the present invention is the same as that of the first embodiment shown in FIG. 1. FIG. 4 is a block diagram illustrating in greater detail the double-speed converter 10, frame memory 20, correction data decision unit 30, correction data appending unit 40 and correction processor 50.

The double-speed converter 10 includes a first line memory 11, a second line memory 12, a first selector 13, a memory controller 14, a third line memory 15, a fourth line memory 16 and a second selector 17. The correction data decision unit 30 includes a memory controller 14, a fifth line memory 31, a sixth line memory 32, a third selector 33 and correction data deciding unit 34. It should be noted that the frame memory 20 is a single frame memory having a memory capacity capable of storing at least two frames of data.

In this arrangement, video signal data from the correction data appending unit 40 is stored in the first line memory 11 and second line memory 12 alternatingly line by line. The first selector 13 is controlled so as to read video signal data out of the second line memory 12 at the line on which video signal data is written to the first line memory 11, and to read video signal data out of the first line memory 11 at the line on which video signal data is written to the second line memory 12. The output of the first selector 13 is stored as frame data in the frame memory 20 via the memory controller 14.

The reading of data from the first line memory 11 and second line memory 12 is controlled in such a manner that four successive pixels of data are read out simultaneously. This can be implemented as follows: In a case where the video signal data is input in one phase, the line memories 11 and 12 can each be constructed by four line memories, by way of example. By storing video signal data in the four line memories at the same addresses in the order of the pixels and reading the data out of these four line memories simultaneously, four successive pixels of data can be read out simultaneously. In a case where the video signal data is input in two phases, the first line memory 11 and second line memory 12 can each be constructed by two dual-port memories. Control is exercised in such a manner that video signal data is stored in the two dual-port memories at the same addresses in the order of the pixels at a clock rate identical with that of the input video signal, and such that read-out is performed simultaneously from the two dual-port memories at double the clock rate.

The memory controller 14 exercises control so as to write video signal data, which is input in four phases, to the frame memory 20 two phases at a time at double the speed, and so as to read out the data two phases at a time at double the speed, expand the data into four phases and output the data.

The video signal data that has been stored in the frame memory 20 is stored in the third line memory 15 and fourth line memory 16, which construct the double-speed converter 10, alternatingly line by line via the memory controller 14. The second selector 17 is controlled so as to read out video signal data, which has been stored in the fourth line memory 16, at the line on which video signal data that has been read out of the frame memory 20 is written to the third line memory 15, and to read video signal data out of the third line memory 15 at the line on which video signal data is written to the fourth line memory 16. Read-out of data from the third line memory 15 and fourth line memory 16 is performed at a clock rate that is double the frame rate of the input frame rate.

The video signal data that is read out of the third line memory 15 and fourth line memory 16 is parallel 4-phase data of four pixels. Accordingly, in a case where the input video signal Din is one phase, the write/read clock of the frame memory 20 has the same rate as that of the input video signal. This is essentially four times the clock rate of the input video signal. Further, in a case where the input video signal Din is two phases, the write/read clock of the frame memory 20 has a rate that is double that of the input video signal. This is essentially double the clock rate of the input video signal.

Accordingly, in order read out data at a frame rate that is double the input frame rate, the third line memory 15 and fourth line memory 16 can each be constructed by a dual-port memory, by way of example. In a case where the input video signal Din is one phase, data is read out at a clock rate that is one-half the clock rate of the input video signal. In a case where the input video signal Din is two phases, data is read out at a clock rate identical with the clock rate of the input video signal. Thus, data can be read out at the required frame rate.

Video signal data that has been stored in the frame memory 20 is stored in the fifth line memory 31 and sixth line memory 32, which construct the correction data decision unit 30, alternatingly line by line via the memory controller 14. The third selector 33 is controlled so as to read out video signal data, which has been stored in the sixth line memory 32, at the line on which video signal data, which has been read out of the frame memory 20, is written to the fifth line memory 31, and to read video signal data out of the fifth line memory 31 at the line on which video signal data is written to the sixth line memory 32. Read-out of data from the fifth line memory 31 and sixth line memory 32 is controlled in such a manner that video signal data read out of the frame memory 20 in four phases will become single-phase data at a timing identical with that of the input video signal data. For example, this can be achieved by constructing each of the fifth and sixth line memories 31 and 32, respectively, by four dual-port memories and reading data out of the four dual-port memories successively at a clock rate identical with that of the input video signal data. It should be noted that in a case where the input video signal data Din is two phases, the above can be achieved as follows, by way of example: The fifth line memory 31 and sixth line memory 32 are each constructed by two dual-port memories, and data is read out of the two dual-port memories successively at a clock rate identical with that of the input video signal data.

The video signal data from the third selector 33 is input to the correction data deciding unit 34 as data of the preceding frame, the signal level of this data is compared with the signal level of the present frame data Din, and the result of comparison is output as 4-bit correction data, by way of example. The correction data appending unit 40 adds the 4-bit correction data to the MSB or LSB of the video signal data Din of the present frame, which is input as 12 bits, thereby obtaining 16-bit data, and outputs this 16-bit data to the double-speed converter 10.

The correction processor 50 generates 12-bit video signal data, the response rate of which has been corrected, by referring to the 4-bit correction of the MSB or LSB from the 4-phase, 16-bit data that is input thereto. The correction of the video signal data can be carried out in only one frame, namely in either the initial double-speed frame or the following double-speed frame, with respect to the video signal having the double-speed frame rate. Alternatively, it is also possible to perform the correction of the video signal data in both of the double-speed frames or to not perform the correction at all.

It should be noted that by making the frame memory 20 a DDR-SDRAM, control can be exercised in such a manner that the writing and reading of data to and from the frame memory 20 is performed at double the speed two phases at a time, and is performed at substantially four times the clock rate of the input video signal. It should be noted that DDR-SDRAM is the abbreviation of Double Data Rate—Synchronous DRAM. Further, in a case where the frame memory 20 is made a SDR-SDRAM, control can be exercised in such a manner that the writing and reading of data to and from the frame memory 20 is performed at substantially four times the clock rate of the input video signal by doubling the pass width. It should be noted that SDR-SDRAM is the abbreviation of Single Data Rate—Synchronous DRAM. As a result, control is exercised so as to write the input video signal data to the frame memory in one-fourth of the time period of the input frame period, perform read-out for generating double-speed frame data in two-fourths of the time period, and read out reference data for deciding response speed correction data in the remaining one-fourth of the time period. Further, the frame memory 20 has a capacity equivalent to at least two frames, and memory space is divided into memory space of a write frame and memory space of a read frame, thereby making it possible to implement the double-speed conversion and over-voltage drive using a single frame memory.

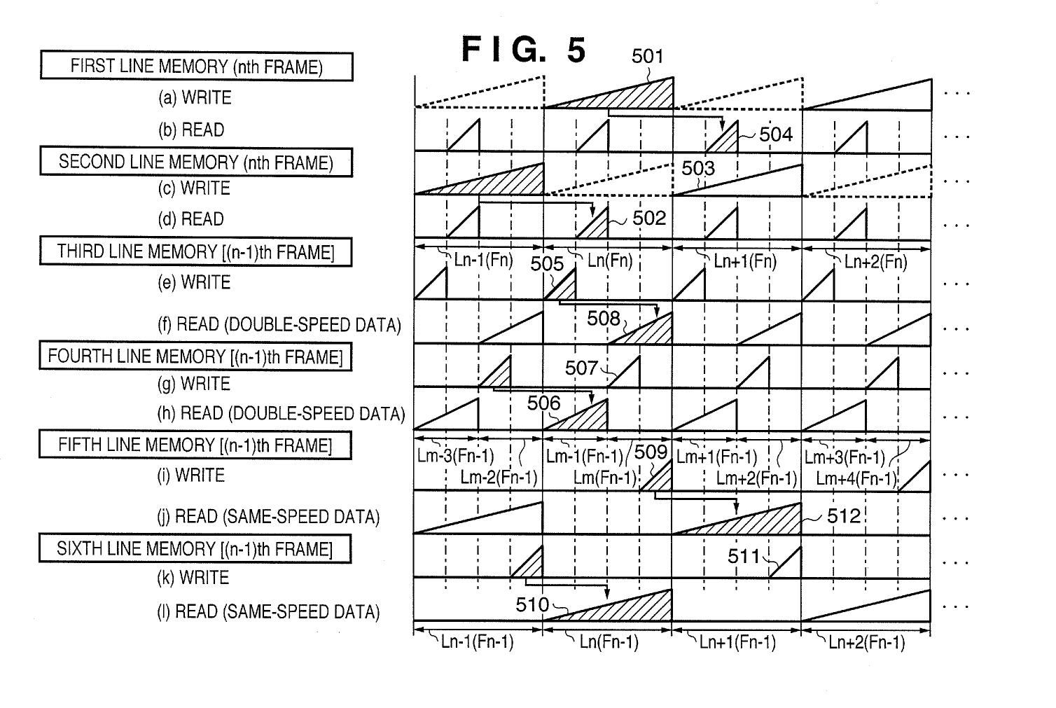

Next, reference will be had to FIG. 5 to describe the operation of each line memory. FIG. 5 is a timing chart for describing write and read operations in each of the line memories 11, 12, 15, 16, 31 and 32 in line intervals of frame Fn.

In the line interval Ln of frame Fn, write control of the first line memory 11 is activated and the video signal data is written to the first line memory 11, as illustrated at (a) of FIG. 5 (501). Meanwhile, the second frame memory 12 does not perform a write operation. The second frame memory 12 reads out video signal data, which was stored in the interval of the preceding line Ln−1, in one-fourth the period of line Ln, as illustrated at (d) of FIG. 5 (502).

In the interval of the next line Ln+1 of frame Fn, write control of the second line memory 12 is activated and the video signal data is written to the second line memory 12, as indicated at (c) of FIG. 5 (503). Meanwhile, the first frame memory 11 does not perform a write operation. The first frame memory 11 reads out video signal data, which was stored in the interval of the preceding line Ln, in one-fourth the period of line Ln+1, as illustrated at (b) of FIG. 5 (504). The video signal data written to the first line memory 11 and second line memory 12 is data to which correction data has been added. The data read out is stored in the frame memory 20.

By repeating the foregoing operation alternatingly line by line and alternatingly selecting read-out data from the first line memory 11 and second line memory 12 by the first selector 13, the input video data Din is written to the frame memory 20.

Further, in the interval of line Ln of frame Fn, write control of the third line memory 15 is activated in the initial one-fourth of the time period. Video signal data corresponding to line Lm of frame Fn−1 that is read out of the frame memory 20 is written, as illustrated at (e) of FIG. 5 (505). Meanwhile, the fourth line memory 16 does not perform a write operation. The fourth line memory 16 reads out the video signal data, which corresponds to line Lm−1 of frame Fn−1 that was stored in the interval of line Ln−1 over the second one-fourth of the time period, in such a manner that the frame rate will be double the input frame rate, as illustrated at (h) of FIG. 5 (506).

In the interval of line Ln of frame Fn, write control of the fourth line memory 16 is activated in the third one-fourth of the time period. Video signal data corresponding to line Lm+1 of frame Fn−1 that is read out of the frame memory 20 is written, as illustrated at (g) of FIG. 5 (507). Meanwhile, the third line memory 15 does not perform a write operation. The fourth line memory 16 reads out the video signal data, which corresponds to line Lm of frame Fn−1 that was stored in the interval of line Ln over the fourth one-fourth of the time period, in such a manner that the frame rate will be double the input frame rate, as illustrated at (f) of FIG. 5 (508).

By repeating the foregoing operation alternatingly line by line and alternatingly selecting read-out data from the third line memory 15 and fourth line memory 16 by the second selector 17, successive frame data is generated. Further, by performing this operation twice in the input frame period, video signal data having a frame rate that is double the input frame rate is generated. The video signal data thus generated is subjected to a response speed correction by the correction processor 50.

In the interval of the next line Ln of frame Fn, write control of the fifth line memory 31 is activated in the fourth one-fourth of the time period. Video signal data corresponding to line Ln+1 of frame Fn read out of the frame memory 20 is written, as indicated (i) of FIG. 5 (509). Meanwhile, the sixth frame memory 32 does not perform a write operation. The sixth line memory 32 reads out the video signal data, which corresponds to line Ln of frame Fn−1 that was stored in the interval of line Ln−1, in such a manner that the frame rate will be identical with the input frame rate, as illustrated at (1) of FIG. 5 (510).

In the interval of the next line Ln+1 of frame Fn, write control of the sixth line memory 32 is activated. Video signal data corresponding to line Ln+2 of frame Fn−1 read out of the frame memory 20 is written, as indicated at (k) of FIG. 5 (511). Meanwhile, the fifth line memory 31 does not perform a write operation. The fifth line memory 31 reads out the video signal data, which corresponds to line Ln+1 of frame Fn−1 that was stored in the interval of line Ln, in such a manner that the frame rate will be identical with the input frame rate, as illustrated at (j) of FIG. 5 (512).

By repeating the foregoing operation alternatingly line by line and alternatingly selecting read-out data from the fifth line memory 31 and sixth line memory 32 by the third selector 33, successive frame data in sync with the input frame rate is generated. The signal level of video signal data thus generated is compared with the signal level of the input video signal data Din in the correction data deciding unit 34, and the result of the comparison is output as 4-bit correction data, by way of example.

Thus, in accordance with the arrangement of the second embodiment, there is provided a display technique that makes it possible to perform a double-speed conversion and appropriate correction processing for improving the response speed characteristic of liquid crystal using a single frame memory.

### Third Embodiment

In this embodiment, an arrangement in which a frame memory for storing video signal data and a frame memory for storing correction data are separately provided will be described.

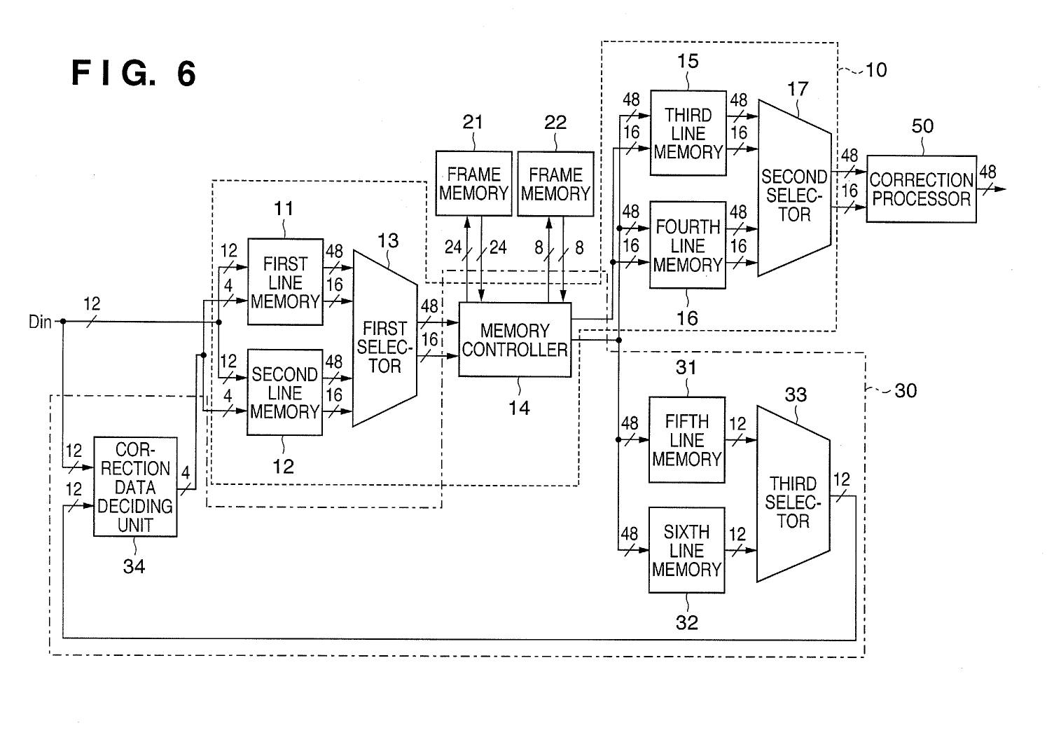

FIG. 6 is a block diagram illustrating a liquid crystal display apparatus according to the third embodiment. Components in FIG. 6 identical with those shown in FIG. 4 are designated by like reference characters. In FIG. 6, first frame memory 21 has a memory capacity capable of storing at least two frames of video signal data, and second frame memory 22 has a memory capacity capable of storing two frames of video signal data.

In this arrangement, video signal data and correction data corresponding to this video signal data is stored in the first line memory 11 and second line memory 12 alternatingly line by line. The first selector 13 is controlled so as to read the video signal data and correction data out of the second line memory 12 at the line on which the video signal data and correction data is written to the first line memory 11, and so as to read the video signal data and correction data out of the first line memory 11 at the line on which the video signal data and correction data is written to the second line memory 12. The video signal data and correction data is stored as frame data in the first frame memory 21 and second frame memory 22, respectively, via the memory controller 14.

Read-out from the first line memory 11 and second line memory 12 is controlled in such a manner that video signal data and correction data corresponding to four successive pixels is read out simultaneously. In a case where video signal data is input in one phase, the line memories 11 and 12 can each be constructed by four line memories, by way of example. Video signal data and correction data is stored in the four line memories at the same addresses in the order of the pixels, and read-out is performed from the four line memories simultaneously. In a case where the video signal data is input in two phases, control is performed as follows: The line memories 11 and 12 are each be constructed by two dual-port memories. Control is exercised in such a manner that video signal data and correction data is stored in the two dual-port memories at the same addresses in the order of the pixels at a clock rate identical with that of the input video signal, and such that read-out is performed simultaneously from the two dual-port memories at double the clock rate.

The memory controller 14 exercises control so as to write video signal data and correction data, which is input in four phases, to the first frame memory 21 and second frame memory 22, respectively, two phases at a time at double the speed, and so as to read out the data two phases at a time at double the speed, expand the data into four phases and output the data.

The video signal data and correction data that has been stored in the first frame memory 21 and second frame memory 22, respectively, is stored in the third line memory 15 and fourth line memory 16, which construct the double-speed converter 10, alternatingly line by line via the memory controller 14. The second selector 17 reads out video signal data, which has been stored in the fourth line memory 16, at the line on which video signal data and correction data that has been read out of the first frame memory 21 and second frame memory 22 is written to the third line memory 15, and reads video signal data and correction data out of the third line memory 15 at the line on which the fourth line memory 16 is written. Read-out of data from the third line memory 15 and fourth line memory 16 is performed at a clock rate that is double the frame rate of the input frame rate.

The video signal data and correction data that is read out of the third line memory 15 and fourth line memory 16 is parallel 4-phase data of four pixels. Accordingly, in a case where the input video signal Din is one phase, the write/read clock of the first frame memory 21 and second frame memory 22 has the same rate as that of the input video signal. This is essentially four times the clock rate of the input video signal. Further, in a case where the input video signal Din is two phases, the write/read clock of the first frame memory 21 and second frame memory 22 has a rate that is double that of the input video signal. This is essentially double the clock rate of the input video signal.

Accordingly, in a case where the line memories 15 and 16 are each constituted by, e.g., a dual-port memory and video signal data Din is one phase, data is read out at a clock rate that is one-half the clock rate of the input video signal, thereby obtaining a frame rate that is double the input frame rate. Further, in a case where the input video signal Din is two phases, data is read out at a clock rate identical with the clock rate of the input video signal, thereby obtaining a frame rate that is double the input frame rate.

Video signal data that has been stored in the first frame memory 21 is stored in the fifth line memory 31 and sixth line memory 32, which construct the correction data decision unit 30, alternatingly line by line via the memory controller 14. The third selector 33 reads out video signal data, which has been stored in the sixth line memory 32, at the line on which video signal data, which has been read out of the first frame memory 21, is written to the fifth line memory 31, and reads video signal data out of the fifth line memory 31 at the line on which the sixth line memory 32 is written. Read-out of data from the fifth line memory 31 and sixth line memory 32 is controlled in such a manner that video signal data read out of the first frame memory 21 in four phases will become single-phase data at a timing identical with that of the input video signal data. For example, this can be achieved by constructing each of the fifth and sixth line memories 31 and 32, respectively, by four dual-port memories and reading data out of the four dual-port memories successively at a clock rate identical with that of the input video signal data. It should be noted that in a case where the input video signal data Din is two phases, the above can be achieved as follows, by way of example: The line memories 31 and 32 are each constructed by two dual-port memories, and data is read out of the two dual-port memories successively at a clock rate identical with that of the input video signal data.

The video signal data from the third selector 33 is input to the correction data deciding unit 34 as data of the preceding frame, the signal level of this data is compared with the signal level of the present frame data Din, and the result of comparison is output as 4-bit correction data, by way of example. The correction data is input to the first line memory 11 and second line memory 12.

In the mode of the invention described thus far, the video signal data and correction data is stored in common in the first line memory 11, second line memory 12, third line memory 15 and fourth line memory 16. However, it may be so arranged that each of the line memories is divided to store the video signal data and correction data separately.

The correction processor 50 generates 12-bit video signal data, the response rate of which has been corrected, from the video signal data and correction data. The correction of the video signal data can be carried out in only one frame, namely in either the initial double-speed frame or the following double-speed frame, with respect to the video signal having the double-speed frame rate. Alternatively, it is also possible to perform the correction of the video signal data in both of the double-speed frames or to not perform the correction at all.

It should be noted that by using DDR-SDRAMs as the first frame memory 21 and second frame memory 22, control can be exercised in such a manner that the writing and reading of data to and from these frame memories is performed at double the speed two phases at a time, and is performed at substantially four times the clock rate of the input video signal. Further, in a case where SDR-SDRAMs are used as the first frame memory 21 and second frame memory 22, control can be exercised in such a manner that the writing and reading of data to and from the frame memories is performed at substantially four times the clock rate of the input video signal by doubling the pass width. As a result, control is exercised so as to write the input video signal data to the frame memories in one-fourth of the time period of the input frame period, perform read-out for generating double-speed frame data in two-fourths of the time period, and read out reference data for deciding response speed correction data in the remaining one-fourth of the time period. Further, the frame memories 21, 22 each have a capacity capable of storing at least two frames of video signal data and correction data, and memory space is divided into memory space of a write frame and memory space of a read frame. As a result, it is possible to implement the double-speed conversion and over-voltage drive using a single frame memory.

Thus, in accordance with the arrangement of the third embodiment, there is provided a display technique that makes it possible to perform a double-speed conversion and appropriate correction processing for improving the response speed characteristic of liquid crystal. Further, a frame memory for storing video signal data and a frame memory for storing correction data are made independent of each other. Therefore, in a case where over-voltage drive is not required in terms of system configuration, the frame memory for storing correction data can readily be excluded from the structural components of the system. This can result in lower cost.

Thus, in accordance with the present invention as described above, a display technique that makes it possible to improve the response speed characteristic of liquid crystal without complicating memory configuration and control thereof can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-248573, filed Sep. 13, 2006, which is hereby incorporated by reference herein in its entirety.

What is claimed is:

1. A display apparatus to which video signal data including a plurality of frame data is input for displaying an image on a monitor based upon the video signal data, said apparatus comprising:
an input unit adapted to input frame data;
a frame memory adapted to store frame data;
a decision unit adapted to decide correction data by comparing the frame data that has been input by said input unit and the frame data that immediately precedes the input frame data that has been stored in said frame memory;
an add-on unit adapted to add the decided correction data onto the frame data that has been input;
a storage control unit adapted to store the input frame data, onto which the correction data has been added, in said frame memory;
a correction unit adapted to read out the frame data, which has been stored in said frame memory by said storage control unit, at a predetermined frame rate, and to correct the frame data based upon the correction data that has been added onto the frame data; and
a display control unit adapted to display an image on the monitor based upon the corrected frame data.

2. The apparatus according to claim 1, wherein said decision unit reads the immediately preceding frame data out of said frame memory in sync with input of frame data by said input unit, and performs the comparison.

3. The apparatus according to claim 1, wherein said storage control unit comprises a first line memory adapted to temporarily store line data contained in the input frame data onto which the correction data has been added.

4. The apparatus according to claim 1, further comprising a second line memory adapted to temporarily store line data contained in frame data that has been stored in said frame memory by said storage control unit;
wherein said correction unit reads the frame data, onto which the correction data has been added, out of said frame memory via said second line memory.

5. The apparatus according to claim 1, wherein said frame memory has a first frame memory and a second frame memory; and
said storage control unit stores the input frame data onto which the correction data has been added in said second memory in a case where the immediately preceding frame data has been stored in said first frame memory, and stores said input frame data in said first frame memory in a case where the immediately preceding frame data has been stored in said second frame memory.

6. A display apparatus to which video signal data including a plurality of frame data is input for displaying an image on a monitor based upon the video signal data, said apparatus comprising:
an input unit adapted to input frame data;
a first frame memory adapted to store frame data;
a decision unit adapted to decide correction data by comparing the frame data that has been input by said input unit and the frame data that immediately precedes the input frame data that has been stored in said first frame memory;
a second frame memory adapted to store the correction data that has been decided by said decision unit
a storage control unit adapted to store the input frame data in said first frame memory;
a correction unit adapted to read the frame data and the correction data out of said first frame memory and said second frame memory, respectively, at a predetermined frame rate and to correct the frame data based upon the correction data; and
a display control unit adapted to display an image on the monitor based upon the corrected frame data.

7. The apparatus according to claim 1, wherein the monitor comprises a liquid crystal panel.

8. A method of controlling a display apparatus to which video signal data including a plurality of frame data is input for displaying an image on a monitor based upon the video signal data, said apparatus having a frame memory for storing the frame data, said method comprising:
an input step of inputting frame data;
a decision step of deciding correction data by comparing the frame data that has been input at said input step and frame data that immediately precedes the input frame data that has been stored in the frame memory;
an add-on unit step of adding the decided correction data onto the frame data that has been input;
a storage control step of storing the input frame data, onto which the correction data has been added, in the frame memory;
a correction step of reading out the frame data, which has been stored in the frame memory at said storage control step, at a predetermined frame rate, and correcting the frame data based upon the correction data that has been added onto the frame data; and
a display control step of displaying an image on the monitor based upon the corrected frame data.
